(19) United States
(12) Patent Application Publication
(10) Pub. No.: US 2024/0124352 A1
(43) Pub. Date: Apr. 18, 2024

(54) IMPROVEMENT OF GLASS STRENGTH AND FRACTURE TOUGHNESS BY A NON-BRITTLE ABRASION RESISTANT COATING

(71) Applicant: EXXERGY GMBH, Gräfelfing (DE)

(72) Inventors: John BROWN, Gräfelfing (DE); Bulent YOLDAS, Gräfelfing (DE); Thomas C. Sauer, Gräfelfing (DE)

(73) Assignee: EXXERGY GMBH, Gräfelfing (DE)

(21) Appl. No.: 17/997,790

(22) PCT Filed: May 6, 2021
(86) PCT No.: PCT/EP2021/061956

§ 371 Date: Nov. 2, 2022

(30) Foreign Application Priority Data
May 6, 2020 (DE) 10 2020 112 268.3

(51) Int. Cl. C03C 17/30; C03C 17/00

(52) U.S. Cl. CPC C03C 17/30; C03C 17/002; C03C 2217/78; C03C 2218/111; C03C 2218/328

(57) ABSTRACT

The present invention relates to the use of a coating for improving glass strength and fracture toughness comprising the hydrolytic polycondensation product of one or more alkoxysilane(s) with one or more metal oxide(s) and/or metal alkoxide(s) in the presence of water and a catalyst.

### FIELD OF THE INVENTION

The present invention generally relates to methods and systems for improving glass strength and fracture toughness of glass. In particular, the present invention relates to the use of a coating for this purpose comprising the hydrolytic polycondensation product of one or more alkoxysilane(s) with one or more metal or metalloid oxide(s) and/or metal or metalloid alkoxide(s) in the presence of water and a catalyst and/or trigger.

### BACKGROUND

Glass strength drops drastically after glass is exposed to atmospheric moisture (for example in moderate climates down to 1,000 ppm in cold winter weather and up to 10,000 ppm in humid summer weather) and to high forming temperatures where water or hydroxyls are chemically active and break Si—O—Si bonds by creating two terminating Si—OH bonds, weakening the structure and setting up the mechanism that finds hydroxyls at the crack tip of all cracks studied and drives these cracks to eventual breakage. The above behavior is attributed to the presence of surface micro cracks, created within a very short time (e.g. within milliseconds or seconds) during high temperature forming and propagation of cracks assisted by the atmospheric humidity.

Industry uses various methods to improve glass strength, including ion exchange (chemical tempering), thermal tempering, lamination, etc. All these methods have various shortcomings and limitations. For example, widely used methods of ion exchange, and thermal tempering do not work below certain glass thicknesses and have compositional restrictions.

By healing the defects that were created by cooling glass from forming (molten glass temperatures) to rapidly cooling to room—or largely below T_{g}, the glass transition temperature (rigid glass temperatures)—, thereby setting up tremendous stresses between the “outer” surface and the rapidly shrinking interior transgressing from liquid to “solid” state towards equilibrium (ambient) temperatures, these stresses are released by creating micro surface cracks reducing the strength of glass products by up to 200-fold.

The three traditional methods of creating a protective compressive layer depend upon some physical thickness of the glass where the compressive layer is developed. As glass is made thinner, the boundary where compressive layers are meaningful is passed. Cover glass had been 0.7 mm but is heading towards 0.4 and even 0.2 mm. These decreasing thicknesses are approaching the limit of usefulness of ion exchange. In addition, in the example of smartphones, e.g. iPhones, the electronics are printed on a special glass that is devoid of alkalis. It is precisely the alkalis, that is for example, but not limited to, lithium, sodium, and potassium, that are the major players in chemical tempering. These same ions, however, will attack the transistors, liquid crystals and electronics that are required for large flat screen displays.

Inorganic coatings are by nature brittle and eventually tend to develop their own micro-cracks in use. Non-brittle organic coatings, on the other hand, tend to be soft and therefore subject to optical deterioration by abrasion in use. To-date, no commercially available coating has the capability to create covalent bonds with the glass matrix by cracking the hydroxyl-groups (OH⁻) on the glass surface enabling a bridge towards an O—Si—O (or other) covalent bonding, thus healing defects. It is extremely difficult to combine hardness with non-brittleness in the same material. Thus, there is a need of a coating that heals glass surfaces from the flaws introduced in high temperature forming by improving the strength of glass products and simultaneously provide sufficient abrasion resistance.

### SUMMARY OF THE INVENTION

Provided herein is the use of one or more coatings for improving (e. g. mechanical) glass strength and fracture toughness of glass, wherein the one or more coatings comprise the hydrolytic polycondensation product of one or more alkoxysilane(s) of the general formula

RₓSi(OR¹)₄₋ₓ

with one or more metal or metalloid oxide(s) and/or one or more metal or metalloid alkoxide(s) in the presence of water and a catalyst and/or trigger, wherein R is an organic radical, R¹ is independently selected from hydrogen and C₁₋₁₈ alkyl, or isomers or polyvalences thereof, and x is an integer from 0 to 3.

In a further embodiment the present invention is directed to the use provided herein, wherein the catalyst and/or trigger is nitric acid.

In one embodiment the present invention is directed to the use provided herein, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, cycloalkyl and aryl groups, and R²—O—(CH₂)ₙ, or isomers or polyvalences thereof; R¹ is a C₁₋₁₈ alkyl or cycloalkyl, or isomers or polyvalences thereof; R² is independently selected from hydrogen, C₁₋₁₈ alkyl, (C₂H₄O)—(R³)ₘ—, C₂₋₁₈ alkene, or isomers or polyvalences thereof; R³ is independently selected from C₁₋₁₈ alkyl, or isomers or polyvalences thereof; n is an integer from 0 to 10; and m is an integer from 0 to 10.

In a further embodiment the present invention is directed to the use provided herein, wherein the one or more alkoxysilane(s) is selected from β-glycidoxypropyltrimethoxysilane, γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane.

In a further embodiment the present invention is directed to the use provided herein, wherein the one or more metal or metalloid oxide(s) and/or the one or more metal or metalloid alkoxide(s) are selected from oxides and/or alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, or polonium, or even other species.

In a further embodiment the present invention is directed to the use provided herein, wherein the alkoxysilane is β-glycidoxypropyltrimethoxysilane or γ-glycidoxypropyltrimethoxysilane and the metal alkoxide is selected from titanium alkoxides and silicon alkoxides or mixtures thereof.

In a further embodiment the present invention is directed to the use provided herein, wherein glass strength and fracture toughness is improved by healing cracks in the surface of the glass.

In a further embodiment the present invention is directed to the use provided herein, wherein one or more further coatings are applied for improving abrasion-resistance, chemical resistance, birefringence, modification of the index of refraction, increase hardness, protection of photovoltaic or semiconductor devices from potential induced degradation, control of increase in mechanical strength, repelling water by improving hydrophobicity, improving oliphobicity, protection against staining, weathering and/or harm deriving from energy release at the breakage force point.

In a further embodiment the present invention is directed to the use provided herein, wherein the one or more coatings are applied by dip coating, spray coating, vapor deposition, nebulizing, plasma outside deposition, chemical vapor deposition, plasma induced vapor deposition, and/or plasma enhanced vapor deposition.

In a further embodiment the present invention is directed to the use provided herein, wherein the one or more coatings are applied in a controlled atmosphere by pressures below or above atmospheric pressure and/or at temperatures above or below atmospheric temperature.

In a further embodiment the present invention is directed to the use provided herein, wherein the controlled atmosphere comprises conditioned air with a dew point below −20° C. (253K), at or below −50° C. (223K), at or below −78.5° C. (194.7 K), at or below −195.8° C. (77.35K), at or below 27K, or at 4K.

In a further embodiment the present invention is directed to the use provided herein, wherein the controlled atmosphere comprises an industrial or specialty gas.

In a further embodiment the present invention is directed to the use provided herein, wherein the pressure during any of the processes involved in subject invention comprises a pressure up to ambient pressure, an absolute pressure of up to 950 hPa, below 500 hPa, below 100 hPa, below 10 hPa, below 1 hPa, below 0.1 Pa, less than 10⁻⁶ Pa, or even less than 10⁻⁹ Pa.

In a further embodiment the present invention is directed to the use provided herein, wherein unused coating is removed from the glass surface.

In a further embodiment the present invention is directed to the use provided herein, wherein the unused coating is removed by dipping the coated glass into or rinsing the coated glass with a solvent.

In a further embodiment the present invention is directed to the use provided herein, wherein the improvement in glass strength is between 50 to 5000%, above 5000% or above 10000%.

In a further embodiment the present invention is directed to the use provided herein, wherein devitrification is avoided.

In a further aspect the present invention is directed to a glass product, silica or silicate containing product prepared by the use described herein.

In a further aspect the present invention is directed to a coating comprising the hydrolytic polycondensation product of one or more alkoxysilane(s) of the general formula

RₓSi(OR¹)₄₋ₓ

with one or more titanium alkoxides, one or more silicon alkoxides and optionally one or more additional metal or metalloid alkoxide(s) in the presence of water and a catalyst and/or trigger, wherein R is an organic radical, R¹ is independently selected from hydrogen, C₁₋₁₈ alkyl, or isomers or polyvalences thereof, and x is an integer from 0 to 3.

In one embodiment the present invention is directed to coating provided herein, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof, R¹ is a C₁₋₁₈ alkyl, or isomers or polyvalences thereof, R² is independently selected from hydrogen, C₁₋₁₈ alkyl, (C₂H₄O)—(R³)ₘ−, C₂₋₁₈ alkene, or isomers or polyvalences thereof, R³ is independently selected from C₁₋₁₈ alkyl, or isomers or polyvalences thereof, and n and m are independently an integer from 0 to 10, such as 1 to 10.

In a further embodiment the present invention is directed to the coating provided herein, wherein the alkoxysilane is selected from β-glycidoxypropyltrimethoxysilane, γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane.

In a still further embodiment the present invention is directed to a coating provided herein, wherein the one or more additional metal alkoxide is selected from alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, or polonium, or other species.

### BRIEF DESCRIPTION OF THE DRAWINGS

FIG. 1a shows the reaction scheme for a specific alkoxysilane with water in the presence of an acid catalyst (trigger);

FIG. 1b shows the reaction of the reaction product of FIG. 1a with a specific titanium alkoxide;

FIG. 2 is a schematic representation of chemical bonding of the inventive coating on a glass surface (a) and a schematic representation of the immobilization of sodium ions by boron coordination change (b);

FIG. 3 shows strength distribution curves of uncoated and coated samples;

FIG. 4 shows graphs indicating that the strength of float glass samples increases when the tin and air surfaces are coated as measured by “cone cracking load” technique.

FIG. 5a shows a fracture pattern of uncoated glass;

FIG. 5b shows an exemplary fracture pattern of glass coated according to the invention;

FIG. 6 shows sodium leach from coated and uncoated glass, the coating containing boron;

FIG. 7 shows a sample of a glass produced entirely by using the inventive sol gel process.

### DETAILED DESCRIPTION

The present invention provides a sol-gel composition in the form of a coating as provided herein that is an organic-inorganic polymer that transforms to a true glass amorphous network healing the flaws introduced by rapid cooling and differential expansion. In particular, the present invention is directed to the use of one or more coatings for improving (mechanical) glass strength and fracture toughness of glass, wherein the one or more coatings comprise the hydrolytic polycondensation product of one or more alkoxysilane(s) of the general formula

RₓSi(OR¹)₄₋ₓ

with one or more metal or metalloid oxide(s) and/or one or more metal or metalloid alkoxide(s) in the presence of water and a catalyst and/or trigger, wherein R is an organic radical, R is independently selected from hydrogen and C₁₋₁₈ alkyl, or isomers or polyvalences thereof, and x is an integer from 0 to 3.

This invention recognizes that glass strength deteriorates drastically immediately coming into contact with moisture containing air at forming temperatures and when water is chemically active forming chemical bonds with glass by breaking Si—O—Si and forming Si—OH terminating bonds that are weak points in the surface structure, and by handling forcing the creation of surface micro cracks. The known and practiced glass strengthening methods function by creating a compressive surface layer that must be exceeded before a break can occur. The present invention describes the first method to truly heal surface defects, the creation thereof is common to all glass produced in the past 5,000 years. The use of the coating provided herein improves glass strength and fracture toughness significantly. The coating covalently bonds to the surface of the glass upon application, eradicating existing surface micro-cracks, and their formation in the future, as well as circumventing the strength deterioration due to handling and atmospheric moisture. As the surface cracks or defects are small, e.g. having a diameter in the micrometer scale, or the nanometer scale, or even smaller, after the coating has penetrated the surface flaws it can be removed with solvents prior to thermal curing, leaving the surface as pristine as new glass, but the micro flaw retains enough of the polymer to convert to glass in curing and healing the surface defect, i.e. to be integrated into the glass matrix by the formation of covalent bonds between the one or more coatings and the glass material. Thus, without wishing to be bound by theory, covalent bonds between the coating and the glass may be created by way of chemical reaction by cracking the (terminating) hydroxyl-groups (OH—) on the glass surface enabling a bridge towards an [—O—Si—] covalent bonding or any other covalent bonding. In other words, terminating hydroxyl groups of the uncoated glass surface are cracked by chemical reaction with the one or more coatings and covalent bonds between the reactant part of the one or more coatings and the oxygen atoms on the glass surface resulting from the cracking of the hydroxyl groups are formed. Furthermore, the coating has the surprising properties of being non-brittle (does not develop own surface cracks) yet being virtually as hard and abrasion resistant as the unaltered glass surface. Thus, the use of the coating, i.e. of the hybrid co-polymer (polymer of organic and inorganic elements), provides hardness maximized with sufficient ductility to prevent crack propagation. The coating has the additional benefit of being soluble to facilitate coating and being cured.

One limiting factor in creating true glass is the liquidus temperature, that point in cooling where the first crystal is formed, or upon heating the last crystal goes into solution. Of the periodic chart and list of metal oxides that can be used to produce glass, there is a tremendous limitation in quantity of these metal oxides that will form viable glasses without devitrification (i.e. without crystalizing). The present invention introduces a vast increase in the availability and concentration of metal oxides that can be incorporated into thin films or into bulk glass products. As conversion to true amorphous glass occurs below 500° C., this is lower than the temperatures where one is concerned for devitrification. The new materials can create glasses of extremely high Index of refraction, or other physical properties that have never been available previously to scientists working with true inorganic glasses. An example can be taken from FIG. 7, wherein the left glass is an alumina sol-gel with 64% voids, but under 50 Å diameter (right sample dipped with Isopropyl alcohol to give more transparency, picture taken directly after dipping—ethanol even better because of smaller molecule size). Thus, with the present invention devitrification is avoided or even excluded. This sample has been produced entirely by using the sol gel process without coating. However, it shows that the formulations can be used to produce coatings with very high Al₂O₃ content which is not possible through regular glass melting processes as it would devitrify or crystallize.

With the present invention it is possible to increase the functionality and versatility of glass to the point that other materials can be replaced. As an example, by virtue of the increased mechanical strength of glass, the wall thickness of container glass can be largely reduced, and with that, the weight, resulting in significant carbon footprint reduction as the amount of energy to produce a container is substantially reduced. The reduction of weight also contributes to the possibility that plastic bottles—that are populating and polluting our planet—can possibly become obsolete or at least be replaced to a large extent. In addition, the productivity of glass furnace largely increases as more containers per unit of glass melting area could be produced.

The alkoxysilane to be used in the coating provided herein may generally be any alkoxysilane that can react with one or more metal or metalloid oxide(s) and/or metal or metalloid alkoxide(s), i.e. that has reactive groups or can provide reactive groups upon reaction with water. In one embodiment, the one or more alkoxysilane(s) may be selected from the general formula RₓSi(OR¹)₄₋ₓ.

R may be selected from an organic radical, such as, for example but not limited to, C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof.

A C₁₋₁₈ alkyl group is a saturated straight chain or branched non-cyclic hydrocarbon having, for example, from 1 to 18 carbon atoms, from 1 to 15 carbon atoms, from 1 to 12 carbon atoms, from 1 to 10 carbon atoms, or 1 to 6 carbon atoms. The alkyl group may be selected from the group consisting of methyl, ethyl, n-propyl, i-propyl, n-butyl, i-butyl, s-butyl, t-butyl, n-pentyl, t-pentyl, neo-pentyl, i-pentyl, s-pentyl, hexyl, heptyl, octyl, nonyl, decyl, undecyl, dodecyl, tridecyl, tetradecyl, pentadecyl, hexadecyl, heptadecyl, and octadecyl, or isomers or polyvalences thereof, but is not limited to. The alkyl group may be optionally substituted with further alkyl groups, hydrogen, halogen, and/or —CN, or the like.

A C₁₋₁₈ heteroalkyl group is a C₁₋₁₈ alkyl group as defined above, wherein one or more carbon atoms are substituted by heteroatoms independently selected from the group consisting of oxygen, sulfur and/or silicon.

A C₁₋₁₈ alkoxy group is an alkyl group, as defined above, singularly bonded to oxygen. Representative alkoxy groups include methoxy, ethoxy, n-propoxy, isopropoxy and n-butoxy, but are not limited to.

A C₂₋₁₈ alkene group is an unsaturated hydrocarbon having 2 to 18 carbon atoms and having one or more carbon-carbon double bonds, such as for example, but not limited to, —CH═CH₂, —CH═CH—CH₃, —CH₂—CH═CH₂, —CH═CH—CH₂—CH₃, —CH═CH—CH═CH₂ and the like. The alkene group may be optionally substituted with further alkyl groups, hydrogen, halogen, and/or —CN and the like.

R² in the above formulae may be hydrogen, C₁₋₁₈ alkyl, (C₂H₄O)—(R³)ₘ— or C₂₋₁₈ alkene, or isomers or polyvalences thereof. In one embodiment R² may be (C₂H₄O)CH₂—O—(CH₂)₃—.

R³ may be independently selected from C₁₋₁₈ alkyl, or isomers or polyvalences thereof.

X may be an integer from 0 to 3, for example x may be 1, 2 or 3. n may be an integer from 0 to 10, such as 0, 1, 2, 3, 4, 5, 6, 7, 8, 9 or 10. m may be an integer from 0 to 10, such as 0, 1, 2, 3, 4, 5, 6, 7, 8, 9 or 10.

In one embodiment the one or more alkoxysilane(s) is selected from glycidoxypropyltrimethoxysilanes, such as (1) β-glycidoxypropyltrimethoxysilane or (2) γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane. In one embodiment the alkoxysilane is a glycidoxypropyltrimethoxysilane. In a preferred embodiment the alkoxysilane is γ-glycidoxypropyltrimethoxysilane. These chemicals are many and varied and can be purchased by any number of chemical supply houses.

The one or more metal or metalloid oxide(s) and/or one or more metal or metalloid alkoxide(s) may generally be selected from any metal compound that can react with the one or more alkoxysilane(s). For example, the metal component of these compounds may be selected from boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, or polonium, but is not limited thereto. In one embodiment the one or more metal or metalloid oxide(s) and/or the one or more metal or metalloid alkoxide(s) are selected from oxides and/or alkoxides of aluminum, silicon and/or titanium. In one embodiment the metal is titanium and/or silicon. The alkyl part of the alkoxy group may be selected from methyl, ethyl, n-propyl, i-propyl, n-butyl, i-butyl, s-butyl, t-butyl, n-pentyl, t-pentyl, neo-pentyl, i-pentyl, s-pentyl, hexyl, heptyl, octyl, nonyl, decyl, undecyl, dodecyl, tridecyl, tetradecyl, pentadecyl, hexadecyl, heptadecyl, and octadecyl, or isomers or polyvalences thereof, but is not limited to. In one further embodiment the metal alkoxide may be, but is not limited to, Ti(OCH₃)₄, Ti(OC₂H₅)₄, Ti(OC₃H₇)₄, Ti(OC₄H₉)₄, Zr(OC₂H₅)₄, Zr(OC₃H₇)₄, Zr(OC₄H₉)₄, Al(OC₂H₅)₃, Al(OC₃H₇)₃, Al(OC₄H₉)₃, Si(OCH₃)₄, Si(OC₂H₅)₄, Si(OC₃H₇)₄, CH₃Si(CH₃)₃, or (CH₃)₂Si(OCH₃)Cl, or in lieu of the metals outlined above any other metals. The alkyl group may be optionally substituted with halogen, such as e.g. fluorine, chlorine, bromine, or iodine. In one embodiment, the alkoxysilane is reacted with at least two different metal compounds selected from any of the above defined metal and/or metalloid oxide(s) and/or metal and/or metalloid alkoxide(s). In one embodiment one of the at least two different metal compounds is a silicon compound.

In one embodiment the above-mentioned one or more metal or metalloid oxide(s) and/or the one or more metal or metalloid alkoxide(s) is not an oxide and/or alkoxide of cer. In one embodiment the above-mentioned one or more metal or metalloid oxide(s) and/or the one or more metal or metalloid alkoxide(s) is not an oxide and/or alkoxide of tin. In one embodiment the above-mentioned one or more metal or metalloid oxide(s) and/or the one or more metal or metalloid alkoxide(s) is not an oxide and/or alkoxide of aluminum.

In one embodiment the alkoxysilane is β-glycidoxypropyltrimethoxysilane, γ-glycidoxypropyltrimethoxysilane and the one or more metal or metalloid alkoxide(s) is selected from titanium alkoxide(s) and/or silicon alkoxide(s). For example, the alkoxysilane may be γ-glycidoxypropyltrimethoxysilane and the one or more metal alkoxide may be, but is not limited to be selected from, but is not limited to, Ti(OC₂H₅)₄, Ti(OC₃H₇)₄, Si(OCH₃)₄, Si(OC₂H₅)₄, CH₃Si(CH₃)₃, or (CH₃)₂Si(OCH₃)Cl, or any other metal mentioned outlined above.

In one further embodiment, the coating to be used is the product of hydrolytic polycondensation of γ-glycidoxypropyltrimethoxysilane with titanium alkoxides.

The coating provided can be made hydrophobic when the respective metal compounds contain some alkyl bonds instead of only possessing alkoxy bonds. Alkyl bonds in these compounds are inert, remaining as terminally stable terminal groups with their hydrophobic properties. Hydrophobicity can also be induced to the coating by inclusion of soluble or dispersible fluorine compounds into the precursor coating solution. Fluorine compounds generally used in this field may be used in the inventive coating, such as for example, fluorinated alkyl or alkoxy groups, but not limited to.

Exemplary coatings used according to the invention may be, but are not limited to,

| | | |
|---|---|---|
| γ-glycidoxypropyltrimethoxysilane | 100 | g |
| Ethanol | 25 | g |
| Si(OC₂H₅)₄ | 0 to 25 | g |
| Water | 10 to 12 | g |
| HNO₃ | 0 to 0.3 | g |
| Ti(OC₂H₅)₄ | 25 to 40 | g |
| Water (solvent) | 20 to 150 | g |
| Ethanol (solvent) | 0 to 100 | g |

| | | |
|---|---|---|
| γ-glycidoxypropyltrimethoxysilane) | 8 | g |
| Ethanol | 25 | g |
| H₂O | 8 | g |
| HNO₃ | 0.5 | g |
| Ti(OC₂H₅)₄ | 40 | g |
| H₂O (solvent) | 150 | g |

| γ-glycidoxypropyltrimethoxysilane) | 250 | g | 250 | g | 250 | g |
|---|---|---|---|---|---|---|
| Ethanol | 60 | g | 60 | g | 60 | g |
| Si(OC₂H₅)₄ | — | | — | | 50 | g |
| Water | 25 | g | 25 | g | 30 | g |
| HNO₃ | 0.3 | g | 0.3 | g | 0.3 | g |
| Ti(OC₂H₅)₄ | 100 | g | 100 | g | 100 | g |
| Water (solvent) | 75 | g | 250 | g | 80 | g |
| Ethanol (solvent) | 250 | g | 50 | g | 250 | g |

| | | | | |
|---|---|---|---|---|
| γ-glycidoxypropyltrimethoxysilane | 300 | g | 300 | g |
| Ethanol | 75 | g | 75 | g |
| Si(OC₂H₅)₄ | 75 | g | 75 | g |
| Water | 36 | g | 36 | g |
| HNO₃ | 0.5 | g | | |

| | | | |
|---|---|---|---|
| NH₃OH | 0 | 0.5 | g |

| | | | | |
|---|---|---|---|---|
| Ti(OC₃H₇)₄ | 135 | g | 135 | g |

| | | | |
|---|---|---|---|
| HNO₃ | 0 | 0.5 | g |

| | | | | |
|---|---|---|---|---|
| Water (solvent) | 75 | g | 450 | g |
| Ethanol (solvent) | 300 | g | | |

The coating is soluble in a suitable solvent depending on whether the coating has hydrophilic or hydrophobic properties. In one embodiment, the solvent is an organic solvent. In one embodiment the solvent is a hydrophilic solvent. Non limiting examples of a solvent are alcohol or water, optionally augmented by surfactants. In one embodiment the solvent may be ethanol, propanol, water or mixtures thereof, optionally including surfactants. The amount of solvent is used to adapt the viscosity and/or concentration of the coating and/or the surface tension. In controlling the viscosity and/or concentration of the solution and/or the surface tension, the penetration into the apex of surface flaws may be controlled.

The coating provided herein provides a structure of a soluble organic-inorganic copolymer that deposits on glass surface as a transparent, non-brittle, yet virtually as hard and abrasion resistant film as the substrate glass surface.

In addition to the above, a positive impact with regard to the non-formation of cracks in the glass may be expected from preventing water vapor (typically from humidity in ambient or compressed air) be present in the atmosphere anywhere from the process steps melting, gob formation (or other exposure of molten glass to the atmosphere), hot forming (such as e. g. pressing, blowing, floating, updraw, downdraw, overflow fusion, tube drawing, rod drawing), through finally applying the coating. Preventing water molecules from being present at the glass surface may limit the micro-crack formation. It is believed, without wishing to be bound by theory, that the presence of water vapor may support the crack propagation as the hydroxyl groups that are needed to fill the full valence band of the Silicon atom (4-valent), that, at the surface, needs an (OH) group to complete the 4^{th} valence. Without water vapor present, that valence cannot be filled, and according to the theory, the crack requires significant larger forces to propagate. Even small amounts of water present e.g. in the atmosphere is believed to trigger the crack propagation, and its absence, or at least very low concentration may largely limit crack propagation.

Crack propagation by the coating is prevented inter alia in that the coating penetrates the crack all the way to the tip of the crack to create a maximum effect.

Upon using the coating provided herein mechanical glass strength is improved compared to uncoated glass products. The increase is controllable depending on the coating used and may provide a minimum increase in mechanical strength by 50%. In one embodiment the strength is increased by more than 100%, by more than 150%, by more than 250%, by more than 300%, by more than 500%, by more than 1000%, by more than 1500%, by more than 2000%, by more than 5000%, or by even more than 10000%. The glass strength increases more than 0.5-fold, more than 1-fold, more than 1.5-fold, more than 2.5-fold, more than 3-fold, more then 5-fold, more than 10-fold, more than 15-fold, more than 20-fold, more than 50-fold or even more than 100-fold versus the genuine, untreated glass substrate. The improvement relates to the baseline mechanical strength of untreated glass after melting, forming and cooling. The limitation of increases in mechanical strength may only be restricted by safety related concerns. As the mechanical strength is increased, the resulting available energy released at the break point will result in more violent energy release and showering of smaller glass segment or particles. The improvement in mechanical strength can be easily controlled with the present invention within an accuracy of up to 100%. The change in mechanical strength can be measured by any method known to the skilled person, such as 3-point or 4-point glass probe, ring-on-ring probe, hydrostatic pressure with any fluid building pressure until device breaks, force increase per unit time (comparison of 2 different populations of glass). The effectiveness of the chemical bonding can be proven by quantitative Auger electron spectroscope, electron probe micro-analyzer (EPMA) techniques, or any other method known to the skilled person.

In one embodiment the improvement in glass strength (and toughness) is between 50 to 5000%, such as between 50 to 4500%, between 50 to 4000%, between 50 to 3500%, between 50 to 3000% or between 50 to 2500%. In one embodiment the improvement in glass strength is above 5000% or even above 10000%

The coated glass has a glass strength (and toughness) of at least 150 MPa. For example, the coated glass has a strength of at least 200 MPa, at least 250 MPa, at least 500 MPa or more.

The increase in glass strength along with the increase in ductility may enable the coated glass to withstand high temperature differentials e.g., cooling from ambient or elevated temperatures to cryogenic temperatures or vice versa from cryogenic temperatures to ambient or elevated temperatures. For example, the coated glass may easily withstand temperature differences of more than 50 K, more than 100 K, more than 150 K, more than 200 K, or even more than 250 K when freezing glass from ambient to very low temperatures or when thawing glass that has been kept at temperatures below 0° C. within a very short time frame. In an exemplary embodiment, vials stored at −78° C. (195 K) or at −196° C. (77 K) or at −269° C. (4 K) and being warmed to room temperature within a very short time frame (such as e. g. vials for pharmaceutical vaccines) do not suffer from breakage as both, the glass strength and the ductility of the glass surface will have significantly increased by the application of subject invention.

The index of refraction of the coating can be adjusted to a desired value by adjusting the relative concentration of the metal component in the copolymer.

The glass coated by the coating provided herein may have no worse than 4% haze after 300 cycles in Bayer abrasion testing defined by ASTM-F735.

The increase in glass strength along with the increase in ductility may enable the coated glass to withstand or at least allow a higher impact force deriving from solid objects impacting on glass at more or less high speeds at different angles. In an exemplary embodiment, photovoltaic glass panels, solar thermal glass panels or tubes, or window glass would withstand larger hail balls or stones at higher speed impacting on these panels without causing fracture or other damage. In a further exemplary embodiment, coated glass would withstand higher impacts induced by violent action such as bullets or battering rams or other impacting devices impacting on the coated glass.

The increase in glass strength along with the increase in ductility may enable container glass—including but not limited to glass bottles, glass jars, drinking glasses, or any other glass with a closed or open hollow volume—to withstand significantly higher pressure from inside the container or to withstand significantly higher forces from any impact. In an exemplary embodiment, bottles filled with liquids that contain carbon dioxide can be prone to high or even excessive pressures e. g. from rising ambient temperatures, and therefore, either the glass bottle can be manufactured with a lower wall thickness to same pressure as the non-treated glass or it can withstand significantly higher pressures. By the same token as in above section [0068], without limiting the effect to a particular glass, a bottle, a jar, or a drinking glass could withstand falling on the floor without being damaged at all or at least only causing little damage compared to a wine glass that is not coated with subject coating that usually breaks on impact.

The presence of additional silicon in the coating may also facilitate a better bonding between the coating and glass and may have the additional advantage of lowering the index of refraction for a better match to the substrate glass as well as better adherence of the coating on the glass surface, due to the fact that silicon alkoxides retain some of the alkoxy bonds, even under excess water, and these bonds react with the hydroxyl bonds of the glass surface during the heat treatment. FIG. 2 for example is a schematic representation of a chemical bonding of the coating on a glass surface showing the covalent bonding the coating to the glass (a) and shows the immobilization of sodium ions by boron coordination change.

According to the invention one or more coatings may be applied to the glass substrate. In case more than one coating is applied, the additional coatings may have different properties and may provide different or enhanced functionality to the glass substrate. For example, different coatings may provide different magnitudes of strength. In one embodiment, one coating layer may provide additional oxygen sites or other bridging 2-valent species, such as sulfur, selenium, tellurium, polonium, copper or ytterbium, but not limited thereto, to allow more covalent bonds for a second coating. The second or more coating may provide additional protection against, for example, staining, weathering and/or imposing harm by energy release at the breakage force or may provide additional abrasion-resistance and/or chemical resistance. With the second or further coating the chemical bonds can be selectively created to ensure best uniformity of the bonds creating coatings on an Angstrom or higher level from the tip of the crack, layer-by-layer to the surface, to further control the strength of the glass. In one embodiment, the abrasion resistance may be improved with the second or further coating. The second or more coating may thus provide (1) protection against staining, weathering, and/or harm deriving from energy release at the breakage force point, (2) improvement of abrasion resistance, (3) improving birefringence, (4) modification of the index of refraction, (5) increase hardness, (6) protection of photovoltaic or semiconductor devices from potential induced degradation, (7) control of the increase in mechanical strength to its design strength, within an accuracy of −50%/+100%, (8) fungicidal, antibacterial, and/or antiviral properties, and/or (9) repelling water by hydrophobicity and/or oil, grease etc. by oleophobicity.

Another important aspect relates to the application of the coating to the glass surface. In order for the coating to reach the tip of the crack, it may be conducive that no restraining force, most importantly from oxygen, nitrogen or water molecules or from argon atoms (or other species contained in the atmosphere) prevents this. Therefore, a controlled atmosphere by means of industrial or specialty gases such as e.g. helium, hydrogen, neon, dry air, nitrogen, argon, oxygen, ozone, carbon dioxide or the like or a vacuum is advantageous to facilitate penetration of the coating to the tip of the crack. In one embodiment, the controlled atmosphere is characterized by using helium, hydrogen, neon, oxygen and/or ozone. The vacuum may be of an absolute pressure of up to 950 hPa, preferably below 500 hPa, more preferably below 100 hPa, even more preferably below 10 hPa or even less. In one embodiment the vacuum may be below 1 hPa or, if economically justifiable even more preferably below 0.1 Pa, or even less than 10⁻⁶ Pa, or even less than 10⁻⁹ Pa. The controlled atmosphere may be applied in the application space and/or the space from the glass outlet through the hot forming device.

Additionally or alternatively, heating the chemical solution to just below the boiling point of the solvents and/or having the glass substrate heated to a sufficiently high temperature will open the cracks as well as lowering the viscosity and increasing the penetration of the coating to allow better penetration, and therefore, healing of the surface flaws. Additionally, or alternatively to the above, heating the chemical solution to above the boiling point transforms the same to the gaseous stage or further energizing the chemical solution even to the plasma stage and/or having the glass substrate heated to a sufficiently high temperature will open the cracks as well as further lowering the viscosity and increasing the penetration of the coating to allow better penetration, and therefore, healing of the surface flaws.

The coating can be applied by various methods known to the skilled person in this field. For example, the coating may be applied either from liquid (including gel), from gaseous, or from plasma states. There is a possibility that the coating can be applied from solid states, most likely in the form of nano-powders. The coating may be applied with any suitable application technique used in this technical field. In one embodiment, the coating may be applied, but is not limited to, by dip coating, spray coating, roller coating, vapor deposition (such as CVD, PECVD), nebulizing, plasma outside deposition, chemical vapor deposition and/or plasma induced vapor deposition (such as PICVD).

The application of the coating may be supported by the use of a catalyst, such as e.g. but not limited to water, preferably de-ionized water, more preferably distilled water, even more preferably multiple distilled water, e.g. so called “bi-distilled” water, for example to increase the reaction rate of the coating with the hydroxyl groups in the crack on the glass substrate. Such catalyst may be the presence of a particular specie or may be particular process parameters, such as for example temperature, pressure, plasma, or the like.

It is also encompassed herein that unused or residual coating, that is not required for the chemical reaction to create the covalent bonding needed for the reaction to heal some or all of the micro-fissures, is removed (i.e. recovered) after the coating has been applied, for example by dipping the coated glass into or rinsing the coated glass with a suitable solvent such as water and/or alcohol, such that enough of the coating would remain in the previous cracks to allow the bonding and healing to take effectively place. The suitable solvent may be, but is not limited to, water, ethanol, iso-propanol, or mixtures thereof. Thus, no coating is left other than the quantity that's needed for the reaction healing the micro-fissures for resulting in the same increase in strength while at the same time saving coating and also allowing the pristine glass showing essentially the same visual property as uncoated.

After application the coating is dried to remove the solvent and excess water and then heated to promote the continued condensation or precipitation polymerization of the coating and curing to a dense glassy film. Heat treatment may be conducted at a suitable temperature for a suitable amount of time. For example, the coated glass may be heat treated at 100 to 500° C., such as 100 to 400° C., 100 to 300° C. or 100 to 200° C. for 30 minutes, 60 minutes, 2 h or even longer than 2 h, but is not limited to. Process temperatures of greater than 150° C., and even more than 200° C. may result in shorter treatment and/or curing times, which is generally preferred. The drying step may also be supported by using vacuum of an absolute pressure of 950 hPa, preferably below 500 hPa, more preferably below 100 hPa, even more preferably below 10 hPa or even less.

In some hot forming processes, it might be possible to create a controlled atmosphere or a vacuum of an absolute pressure of up to 950 hPa or less with no or very little water vapor content, e.g. conditioned air with a dew point below −20° C. (253 K), more preferably at or below −50° C. (223 K), more preferably at or below −78.5° C. (194.7 K), if economically justifiable even more preferably at or below −195.8° C. (77.35 K), more preferably at or below −246° C. (27 K), more preferably at −269° C. (4 K) from the outlet of the molten glass to anywhere throughout the forming device or even through an annealing furnace, thus as much as possible preventing water reacting with the glass surface, and therefore, improving the result of the chemicals reacting with the glass surface instead. In addition, the lack or the significant reduction of the presence of water vapor may prevent the crack propagation during the crack formation process, and therefore, less coating material may be required as the depth of the crack and its resulting volume may be smaller and the “penetration resistance” of the coating into the void(s) resulting from the crack may be largely reduced.

With the present invention, any of the process steps from batch storing, batch mixing, batch charging, if applicable batch preheating, melting, refining, gob formation, hot forming etc. until the application of the coating or even the entire or parts of the entire process from batch storing through application of the coating can optionally take place in a controlled atmosphere (as described above) with very low water vapor pressure (water vapor partial pressure).

In order to prepare the coating provided herein, the alkoxysilane compound is first partially hydrolyzed with a limited amount of water in a solvent such as alcohol using an acid catalyst and/or trigger. Limited amount of water here means that at most stoichiometric amounts of water are used, i.e. one mole water per mole reactive group. The catalyst or trigger may be selected from any acid suitable for these kind of chemical reactions, such as, but not limited to, nitric acid, hydrochloride acid, sulfuric acid or the like. In a preferred embodiment the catalyst and/or trigger is nitric acid.

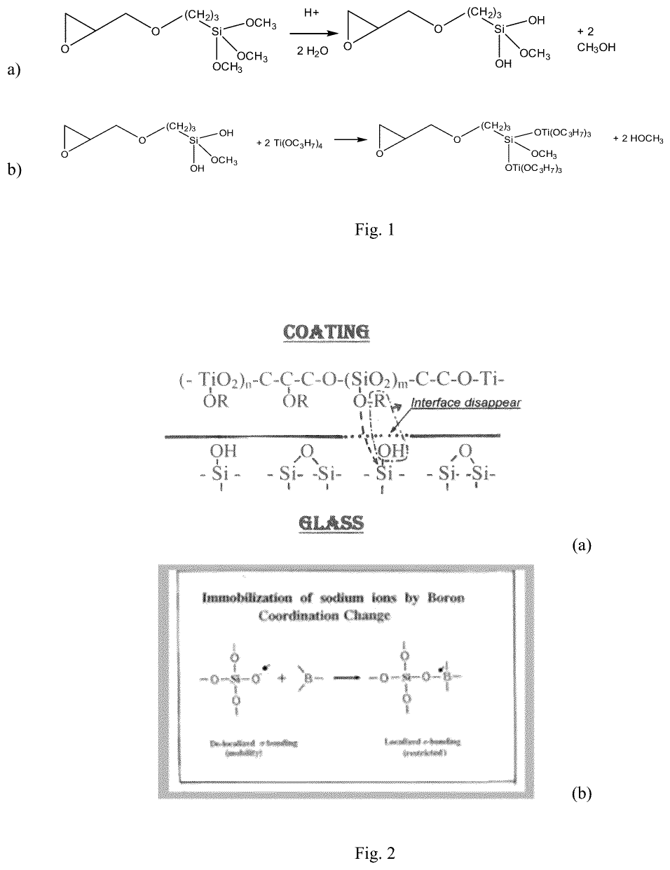

This reaction leads to formation of hydroxyl groups to be reacted with the metal or metalloid oxide(s) and/or metal or metalloid alkoxide(s). One exemplary reaction can be seen in FIG. 1a. In this exemplary reaction glycidoxypropyltrimethoxysilane is reacted with water to give the hydroxylated product. In this process, the glycidoxypropyltrimethoxysilane's methoxy bonds are first hydrolyzed in a solvent, such as in an alcohol, with limited amount of water, not exceeding 3 moles per moles of glycidoxypropyltrimethoxysilane under stirring by an acid catalyst.

The hydrolysis reaction must be given enough time to use up all water introduced into the system, i.e. that no free water remains in the solution for the next reaction step. This reaction consumes all the added water within a short time and creates terminal hydroxyl bonds. Excessive time between the two reactions should be avoided as otherwise the hydrolyzed alkoxysilane will slowly self-polymerize detrimentally affecting homogeneity. According to one embodiment of the invention, the reaction time between the alkoxysilane and water may be less than 30 minutes, such as less than 20 minutes, less than 15 minutes, less than 10 minutes or even less than 5 minutes. For example, the reaction time may be between 5 to 10 minutes, such as 6 to 10 minutes, or 8 to 10 minutes. In one embodiment the reaction time is less than 10 minutes.

In the second step, the metal or metalloid oxide(s) and/or metal or metalloid alkoxide(s) is reacted with the above compound obtained in the first step of the reaction. The metal or metalloid oxide(s) and/or metal or metalloid alkoxide(s) must be introduced within a critical duration in order to prevent a significant self-polymerization of the partially hydrolyzed alkoxysilane. FIG. 1b shows an exemplary reaction between the compound obtained in FIG. 1a and Ti(OC₃H₇)₄. Under these circumstances for example, when the titanium alkoxide is introduced into the solution it can only react with the hydroxyl groups of glycidoxypropyltrimethoxysilane, thereby binding organic and inorganic components in a copolymer chain. This creates oxide bonding between organic & inorganic groups in a hybrid polymer solution (in a soluble form).

At this stage, it is of importance that no free water must be present in the mixture at the end of the first part of the reaction otherwise the metal alkoxide will react with the free water and separately condensate or precipitate. Secondly, and as importantly, excessive time between the two reactions should be avoided as otherwise the hydrolyzed alkoxysilane will slowly self-polymerize detrimentally affecting homogeneity. The second part of the reaction has a minimum time requirement but unlike the first part of the reaction has no maximum time requirement. Most of the remaining alkoxy bonds from the copolymer can be done at any time with further water additions. Further addition of water leads to formation of a structure which is hard and abrasion resistant by removal of excessive organic groups and facilitating longer chain formation of oxide networks. There is, however, a limit of water addition, e.g. around 50% of total volume, the system can tolerate without causing cloudiness of the solution due to the solvent water insolubility.

After this bonding the product shown in FIG. 1b is totally hydrolysable to produce homogeneous inorganic-organic copolymers without fear of segregation or precipitation with further water additions. The resultant polymer is water and alcohol soluble thus can be diluted to any concentration for the deposition of desired film thickness on glass.

The use of the coating will benefit all glass applications and products. For example, but not limited to, the coating may be applied to containers for e.g. beverages, spirits, food, pharmaceuticals; flat glass (e.g. automotive, architectural, solar photovoltaic, solar thermal), electronic devices (e.g. computer displays, laptops displays, smartphones, wafer level packaging); mirrors or mirror substrates, aerospace applications, astronomy applications, ophthalmology devices, optical devices, optical or other communication fibers, textile reinforcement fibers, insulation fibers, tube and/or rod glass (e.g. for pharmaceutical packaging, solar thermal, solar photovoltaic, lighting tubes), mask blanks (for microlithography), glass, ceramic, glass-ceramic, or composite membranes (e. g. for batteries, fuel cells), pressed glass for e.g. high precision reflectors, LED or OLED applications, glass powders, as protection against leaching or for waste vitrification glasses (e.g. ash vitrification, nuclear waste vitrification).

The invention is not limited to a specific glass type but may be applied to any glass and for any purpose. Suitable glass types may include, but are not limited to, soda-lime, boro-silicate, alumino-silicates, opal glass, sapphire, calcium fluoride, chalcogenite glasses, silica (pure or doped), glass ceramics, ceramics, composite materials consisting of any type of glass or ceramic or glass ceramic and at least one other material, or the like. For example, the coating may be applied to all glasses that are molten at high temperatures of min. 450° C., at temperatures of more than 1100° C., or temperatures of more than 1400° C. Generally, there is no limitation concerning the upper temperature, i.e. the coating may be applied to any molten or formed glass upon reaching a temperature suitable to apply the coating. The coating may thus be applied, for example, to all glasses manufactured or formed at or around the transition temperature (T_{g})+/−300° C., or all glass produced by applying the sol-gel process at temperatures below 1200° C., below 1000° C., below 850° C., below 600° C., below 450° C., below 300° C., or even below 150° C., such coating being applied upon reaching a suitable temperature. In one embodiment, the coating may be applied at temperatures below 450° C.

In one embodiment, the inventive coating is not applied to polymeric substrates. In one embodiment, the inventive coating is not applied to polycarbonates. In one embodiment, the inventive coating is not applied to acrylates.

The invention is also suitable for all possible preparation processes, such as, but not limited to, any hot forming technology, in particular but not limited to press-blow (e.g. in individual section machines, NNPB (narrow neck pressure blow)), float glass, rolled flat glass, tube forming (e.g. tube drawing by Danner process, Vello process etc.), pressing, updraw, downdraw, overflow fusion, pressing, mouth-blowing, casting, carrousel type machines, tube-to-container conversion; any temperature cooling or heating device to control the glass temperature and glass temperature distribution.

In a further aspect the present invention is directed to a glass or silica containing product having a coating as described herein.

The coating on the glass product may have a thickness that is suitable for the respective purpose. For example, the coating may have a thickness of less than 10 microns. In one embodiment the coating may have a thickness of less than 5 microns, such as less than 3 microns or less than 2 microns, or even less than 1 micron. Even thinner coatings may be applied. The coating may be controlled in several ways, such as the viscosity and/or concentration of the coating solution and/or surface tension, the duration of applying the coating to the glass, the temperature, the control of atmosphere, the ambient pressure or vacuum of an absolute pressure as defined above, and the like.

It is generally favorable to provide the coating as thin as possible.

In a further aspect the present invention is directed to a coating comprising the hydrolytic polycondensation product of one or more alkoxysilane(s) of the general formula

RₓSi(OR¹)₄₋ₓ

with one or more titanium alkoxides, one or more silicon alkoxides and optionally one or more additional metal or metalloid alkoxide(s) in the presence of water and a catalyst and/or trigger, wherein R is an organic radical, R¹ is independently selected from hydrogen, C₁₋₁₈ alkyl, or isomers or polyvalences thereof, and x is an integer from 0 to 3.

In a still further aspect the present invention is directed to a method for improving (mechanical) glass strength comprising applying one or more coating(s) as provided herein to the glass. The one or more coating(s) is/are applied as described above. The method may further comprise the step of preparing the one or more coating(s) as provided herein.

Here, R is selected from C₁₋₁₈ alkyl, C₁₋₁₈ alkoxy, C₂₋₁₈ alkene, phenyl, R²—(CH₂)ₙ—, and R²—O—(CH₂)ₙ, or isomers or polyvalences thereof, R¹ is a C₁₋₁₈ alkyl, or isomers or polyvalences thereof, R² is independently selected from hydrogen, C₁₋₁₈ alkyl, (C₂H₄O)—(R³)ₘ—, C₂₋₁₈ alkene, or isomers or polyvalences thereof, R³ is independently selected from C₁₋₁₈ alkyl, or isomers or polyvalences thereof, and n is an integer from 0 to 10, such as 1 to 10. The definitions as provided above also apply here.

In a further embodiment the present invention is directed to the coating provided herein, wherein the alkoxysilane is selected from glycidoxypropyltrimethoxysilane, such as β-(1) glycidoxypropyltrimethoxysilane or (2) γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane. In one embodiment the alkoxysilane is glycidoxypropyltrimethoxysilane.

In a still further embodiment the present invention is directed to a coating provided herein, wherein the one or more additional metal or metalloid alkoxide is selected from alkoxides of any metal or metalloid in the periodic chart. For example, the metal or metalloid alkoxide may be selected from, but is not limited to, boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, or polonium, but is not limited to.

All the above embodiments may be combined in any possible way.

### EXAMPLES

To describe the present invention in more detail and assist in understanding the present description, the following non-limited examples are provided to fully illustrate the scope of the description and are not to be construed as specifically limiting the scope thereof.

### Example I

A transparent, hard, and non-brittle coating solution is prepared as follows. 100 grams of glycidoxypropyltrimethoxysilane,

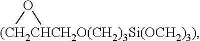

is mixed with 100 grams of ethyl alcohol, C₂H₅OH. To this mixture, 8 grams of water and 0.3 grams of nitric acid, HNO₃, is added and stirred for 10 minutes. This procedure hydrolyzes the methoxy groups of the compound converting them to hydroxyls. After this, 40 grams of titanium ethoxide, Ti(OC₂H₅)₄, is also added and stirred for another 10 minutes to react with the hydroxyl bonds thus, chemically bonding the titanium compounds to glycidoxypropylsilane's molecular structure through oxygen. Once titanium and organic component chemically bonded by this procedure, additional water can be added without fear of causing segregated condensation or precipitation. This water causes further polymerization of the system to long chains and leads to hardness of the coating by stripping the excessive organics from the structure.

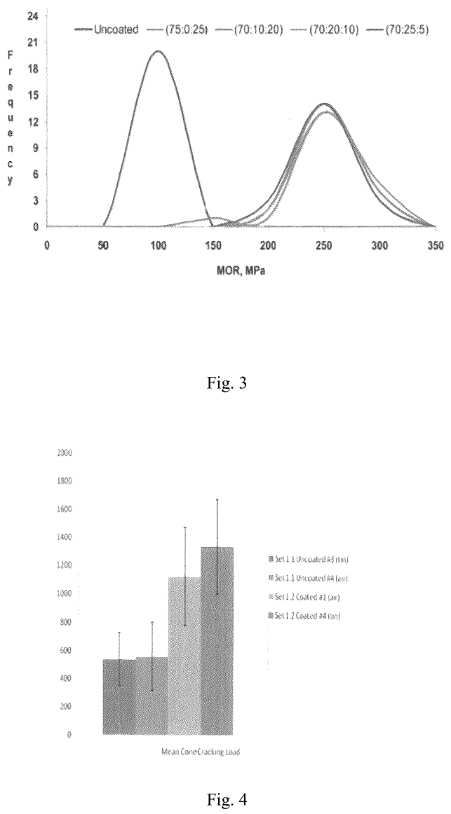

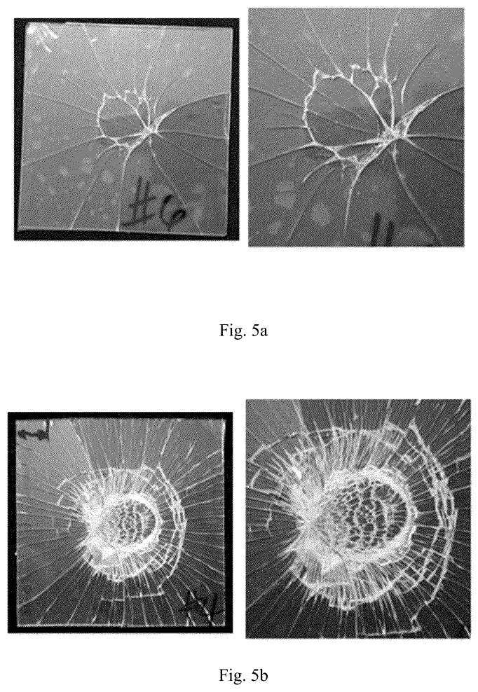

A number of 10 cm×10 cm, 2 mm thick float glass samples are coated by dipping into this solution and heat treated for 30 minutes at 130° C. Their abrasion resistance is tested by ASTM F-735 Bayer abrasion testing method for 300 cycles and found to be around 1.0 which is virtually similar to the abrasion resistance of uncoated glass surface. The strengths of these samples were also measured by the customary ring over ring method and “cone cracking load” method at Penn State University. The results are shown in FIG. 3. The uncoated glass showed the typical bell shaped strength distribution between 50 to 150 MPa with an average mean value of around approximately 100 MPa; whereas the test of the coated samples gave a strength distribution in the range of approximately 200 to 350 MPa, the mean strength was around approximately 250 MPa, a strength increase of 2.5 fold. FIG. 4 is a comparison of the average and the range of the mean cone cracking load of the glass samples. It can be seen that the “tin side” of the glass (i.e. the bottom of the floating glass that is in contact with the tin bath on which the glass floats) has a significantly lower crack resistance than the “air side” (i.e. the top of the floating glass) due to microscopic defects imposed through the above and other phenomena. More importantly are defects in the surface support steel rollers that the glass is pulled along after leaving the tin bath. These rollers may create scratches in the bottom glass surface. Some of the defects in the steel rollers may be caused by pieces of glass in the cut off process.

### Example II

An abrasion resistant non-brittle coating solution is prepared as in Example I, except titanium iso-propoxide, Ti(OC₃H₇)₄, was used instead of titanium ethoxide. The abrasion resistance and the strength results were virtually similar.

### Example III

A number of coating solutions were prepared as in Example I, except zirconium and aluminum alkoxides, Zr(OC₃H₇)₄ and Al(OC₄H₉)₃, were used instead of titanium ethoxide Ti(OC₂H₅)₄.

### Example IV

100 grams of glycidoxypropyltrimethoxysilane is mixed with 100 grams of ethyl alcohol, C₂H₅₀H. To this mixture 8 grams of water and 0.3 grams of nitric acid is added and stirred for 10 minutes. Then 40 grams of titanium isopropoxide, Ti(OC₃H₇)₄, and 5 grams of silicon ethoxide, Si(OC₂H₅)₄, is also added and stirred another 10 minutes, polymerizing them with the glycidoxypropyltrimethoxysilane. After this is done, 150 grams of water and 30 grams of ethanol is added to further polymerize the structure to higher molecular size as well as stripping most of the organic terminal bonds from the structure.

This solution was also coated on glass samples and tested for the strength and abrasion resistance. Similar results, as shown in Example 1, were obtained.

### Example V

The coating solution was prepared as in Example IV, except silicon was introduced from 3 grams of silicon methoxide, Si(OCH₃)₄. The results were similar to that of given in Example IV.

To investigate the effect of coating on the strength of glass as a function of glass thickness, a solution was prepared as in example IV and coated on float glass samples having various thicknesses. As the glass got thinner the efficacy of the coating increased. The coating increased the average strength of glass from 130 MPa to −250 MPa when the thickness was 3 mm, but it increased to over 300 MPa when the thickness was 2 mm.

### Example VI

The coating solution is prepared as in Example IV, except 3 grams of silicon methoxide, Si(OCH₃)₄ was used instead of silicon ethoxide, Si(OC₂H₅)₄. The results were similar to that given in Example IV.

### Example VII

The coating solution is prepared as in Example IV, except 4 grams of methyltrimethoxysilane, CH₃Si(OCH₃)₃, instead of silicon methoxide, is added along with titanium isopropoxide. The resultant coating on glass, not only strengthened, the glass similarly but it made it hydrophobic, thus providing an additional property and protection against water related staining and chemical effects.

### Example VIII

The coating solution is prepared as in Example IV, except instead of silicon ethoxide, 2 grams of dimethylmethoxychlorosilane, (CH₃)₂Si(OCH₃)Cl, was added along with titanium isopropoxide, Ti(OC₃H₇)₄. The resultant coating, not only strengthened the glass but, was also hydrophobic.

### Example IX

The coating solution is prepared as in Example IV. Hydrophobicity was introduced by adding 2 grams of commercially available fluorine compound in solution. The results of the strength increase was similar to Examples I & IV, except the coating had the additional property of being hydrophobic and oilophobic (oleophobic).

### Example X

The following Tables 1 and 2 provide additional experimental evidence that the use of the coating as provided herein (all coated examples are within the inventive coating) leads to an improvement in glass strength.

TABLE 1

| | Strength 2 mm glass [MPa] | | |
|---|---|---|---|
| Sample # | Uncoated | Coated | Difference |
| 2-1 | 157 | | |
| 2-2 | 159 | | |
| 2-3 | 266 | | |
| 2-4 | 178 | | |
| 2-5 | 79 | | |
| 2-6 | | 262 | |
| 2-7 | | 301 | |
| 2-8 | | 364 | |
| 2-9 | | 292 | |
| 2-10 | | 314 | |
| Averages | 167.8 | 306.6 | 82.7% |

TABLE 2

| | Strength 3 mm glass [MPa] | | |
|---|---|---|---|
| Sample# | Uncoated | Coated | Difference |
| 3-1 | 128 | | |
| 3-2 | 106 | | |
| 3-3 | 110 | | |
| 3-4 | 136 | | |
| 3-5 | 171 | | |
| 3-6 | | 213 | |
| 3-7 | | 227 | |
| 3-8 | | 283 | |
| 3-9 | | 311 | |
| 3-10 | | 246 | |
| Averages | 130.2 | 256 | 96.6% |

FIGS. 5a and 5b show an example of the strengthening of glass according to the present invention. The uncoated sample (FIG. 5a) displays a relatively moderate fracture pattern, which is a proof of relatively low energy needed for destruction. Here, a low force of about 79 MPa (about 11,600 psi) created the fracture pattern. On the contrary, the coated sample (FIG. 5b) displays a relatively significant fracture pattern, which is a proof of a relatively higher impact needed for destruction, and hence, for improved mechanical glass strength. Here, a higher force of about 364 MPa (about 53,000 psi) was necessary. The surface coating was approximately 2.4 microns thick.

### Example XII

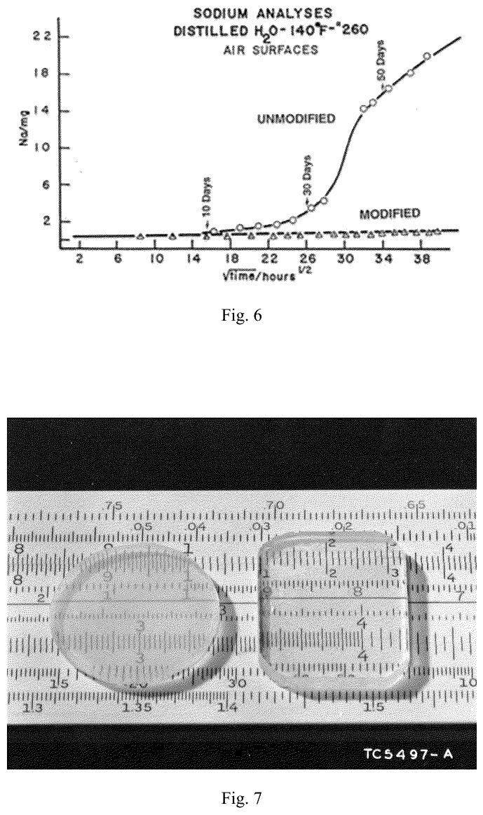

FIG. 6 is a dealkalization analysis of (sodium) of coated and uncoated glass whereby the coating takes terminated silica hydroxyl bond —Si—OH, and after the reaction now bridges the oxygen with boron —O—B−O− instead of e. g. —O—Si—O—. The graphs show an accumulated sodium leach from 4.5″×4.5″ clear float glass samples immersed in 250 cc H₂O at 60° C. (140° F.). As can be seen from the graphs, essentially no sodium leaches out from the modified (coated) surface contrary to uncoated glass.

1. A method of forming on a glass surface one or more coatings for improving glass strength and fracture toughness, the method comprising forming on the glass surface a hydrolytic polycondensation product of one or more alkoxysilane(s) of the general formula
RₓSi(OR¹)₄₋ₓ
with one or more metal or metalloid oxide(s) and/or one or more metal or metalloid alkoxide(s) in the presence of water and a catalyst or trigger, wherein R is an organic radical, R¹ is independently selected from hydrogen and C₁₋₁₈ alkyl, or isomers or polyvalences thereof, and x is an integer from 0 to 3.

2. The method according to claim 1, wherein the catalyst or trigger is nitric acid.

3. The method according to claim 1, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof; R¹ is a C₁₋₁₈ alkyl, or isomers or polyvalences thereof, R² is independently selected from hydrogen, C₁₋₁₈ alkyl, (C₂H₄O)—(R³)ₘ—, C₂₋₁₈ alkene, or isomers or polyvalences thereof; R³ is independently selected from C₁₋₁₈ alkyl, or isomers or polyvalences thereof; n is an integer from 0 to 10; and m is an integer from 0 to 10.

4. The method according to claim 1, wherein the one or more alkoxysilane(s) is selected from β-glycidoxypropyltrimethoxysilane, γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane.

5. The method according to claim 1, wherein the one or more metal or metalloid oxide(s) and/or the one or more metal or metalloid alkoxide(s) are selected from oxides and/or alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, and polonium.

6. The method according to claim 1, wherein the one or more alkoxysilane is (3-glycidoxypropyltrimethoxysilane or γ-glycidoxypropyltrimethoxysilane and the one or more metal or metalloid alkoxide is selected from titanium alkoxides and silicon alkoxides or mixtures thereof.

7. The method according to claim 1, wherein glass strength and fracture toughness is improved by healing cracks in the surface of the glass.

8. The method according to claim 1, wherein the one or more coatings are applied for improving abrasion-resistance, chemical resistance, birefringence, modification of the index of refraction, increase hardness, protection of photovoltaic or semiconductor devices from potential induced degradation, control of increase in mechanical strength, repelling water by improving hydrophobicity, improving oleophobicity, protection against staining, weathering and/or harm deriving from energy release at the breakage force point, enabling fungicide, antibacterial and/or antiviral properties.

9. The method according to claim 1, wherein the one or more coatings are applied by dip coating, spray coating, vapor deposition, nebulizing, plasma outside deposition, chemical vapor deposition, plasma induced vapor deposition, and/or plasma enhanced vapor deposition.

10. The method according to claim 1, wherein the one or more coatings are applied in a controlled atmosphere by pressures below or above atmospheric pressure and/or at temperatures above or below atmospheric temperature.

11. The method according to claim 10, wherein the controlled atmosphere comprises conditioned air with a dew point below −20° C. (253K), at or below −50° C. (223K), at or below −78.5° C. (194.7 K), at or below −195.8° C. (77.35K), at or below 27K, or at 4K.

12. The method according to claim 10, wherein the controlled atmosphere comprises an industrial or specialty gas.

13. The method according to claim 10, wherein the pressure comprises an absolute pressure of 950 hPa, below 500 hPa, below 100 hPa, below 10 hPa, below 1 hPa, below 0.1 Pa, less than 10⁻⁶ Pa, or even less than 10⁻⁹ Pa.

14. The method according to claim 1, wherein unused coating is removed from the glass surface.

15. The method according to claim 14, wherein the unused coating is removed by dipping the coated glass into or rinsing the coated glass with a solvent.

16. The method according to claim 1, wherein the improvement in glass strength is between 50 to 5000%, above 5000% or above 10000%.

17. The method according to claim 1, wherein devitrification is avoided.

18. Glass, silica or silicate containing product prepared by the use of the method of claim 1.

19. A coating on a substrate comprising the hydrolytic polycondensation product of one or more alkoxysilane(s) of the general formula
RₓSi(OR¹)₄₋ₓ
with one or more titanium alkoxides, one or more silicon alkoxides and optionally one or more additional metal or metalloid alkoxide(s) in the presence of water and a catalyst or trigger, wherein R is an organic radical, R¹ is independently selected from hydrogen, C₁₋₁₈ alkyl, or isomers or polyvalences thereof, and x is an integer from 0 to 3.

20. The coating C-eating according to claim 19, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof, R¹ is a C₁₋₁₈ alkyl, or isomers or polyvalences thereof, R² is independently selected from hydrogen, C₁₋₁₈ alkyl, (C₂H₄O)—(R³)ₘ—, C₂₋₁₈ alkene, or isomers or polyvalences thereof, R³ is independently selected from C₁₋₁₈ alkyl, and n and m are independently an integer from 1 to 10.

21. The coating according to claim 19, wherein the alkoxysilane is selected from β-glycidoxypropyltrimethoxysilane, γ-glycidoxypropyltrimethoxysilane, γ-methacryloxypropylsilane methoxyethylsilane, methyltrimethoxysilane, dimethyldimethoxysilane, trimethylmethoxysilane, ethyltrimethoxysilane, diethyldimethoxysilane, and triethylmethoxysilane.

22. The coating according to claim 19, wherein the one or more additional metal or metalloid alkoxide is selected from alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, and polonium.

23. The method according to claim 2, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof; R¹ is a C₁₋₁₈ alkyl, or isomers or polyvalences thereof, R² is independently selected from hydrogen, C₁₋₁₈ alkyl, (C₂H₄O)—(R³)ₘ—, C₂₋₁₈ alkene, or isomers or polyvalences thereof; R³ is independently selected from C₁₋₁₈ alkyl, or isomers or polyvalences thereof; n is an integer from 0 to 10; and m is an integer from 0 to 10.

24. The method according to claim 11, wherein the controlled atmosphere comprises an industrial or specialty gas.

25. The method according to claim 11, wherein the pressure comprises an absolute pressure of 950 hPa, below 500 hPa, below 100 hPa, below 10 hPa, below 1 hPa, below 0.1 Pa, less than 10⁻⁶ Pa, or even less than 10⁻⁹ Pa.

26. The method according to claim 12, wherein the pressure comprises an absolute pressure of 950 hPa, below 500 hPa, below 100 hPa, below 10 hPa, below 1 hPa, below 0.1 Pa, less than 10⁻⁶ Pa, or even less than 10⁻⁹ Pa.

27. The coating according to claim 20, wherein the alkoxysilane is selected from β-glycidoxypropyltrimethoxysilane, γ-glycidoxypropyltrimethoxysilane, γ-methacryloxypropylsilane methoxyethylsilane, methyltrimethoxysilane, dimethyldimethoxysilane, trimethylmethoxysilane, ethyltrimethoxysilane, diethyldimethoxysilane, and triethylmethoxysilane.

28. The coating according to claim 20, wherein the one or more additional metal or metalloid alkoxide is selected from alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, and polonium.

29. The coating according to claim 21, wherein the one or more additional metal or metalloid alkoxide is selected from alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, and polonium.
